(19) United States
(12) Patent Application Publication
(10) Pub. No.: US 2006/0168572 A1
(43) Pub. Date: Jul. 27, 2006

(54) Generic software conversion engine

(76) Inventors: Niklas Backlund, Stockholm (SE); Sven Hedberg, Johanneshov (SE)

Correspondence Address: ERICSSON INC., 6300 LEGACY DRIVE, M/S EVR C11, PLANO, TX, 75024, US

(21) Appl. No.: 11/041,564

(22) Filed: Jan. 24, 2005

(51) Int. Cl. G06F 9/45

(52) U.S. Cl. 717/137

(57) ABSTRACT

A system and method for converting a software system from a first version to a second version. Conversion software is treated as a series of individual conversion steps that, taken together, convert the software system. A conversion database stores a list of conversion steps and associated capabilities. Each conversion step performs a partial conversion of the software system, and different combinations of the conversion steps may be utilized to convert the software system from the first version to the second version, with each combination requiring a different number of steps. A Generic Upgrade Engine (GUE) builds a conversion graph from the list of available conversion steps and capabilities, and searches the graph to determine the shortest path from the first version to the second version. This creates a conversion program with the fewest number of conversion steps. If a requested version is not supported, the GUE selects the closest alternative.

### FIELD OF THE INVENTION

The present invention relates to a method and apparatus for converting a software system from a first version to a second version. In particular, and not by way of limitation, the invention is directed to a method and system for selecting from a plurality of available conversion steps, a set of conversion steps that provides the shortest path between the first version and the second version.

### BACKGROUND ART

When upgrading any software-controlled processor (for example, a node in a telecommunications network) it is important to know in advance the node's current version (from-version) and the version to which it is being updated (to-version). Then the correct upgrading software must be selected to support the upgrade between the from- and to-versions. Some conversions systems can handle different from-versions, but must know the to-version.

Today, conversion systems must maintain different versions of the conversion software for all combinations of from- and to-versions that must be supported. Due to the many different combinations of from- and to-versions, problems often arise. For example, due to system-resource limitations, a conversion system may not support all update paths. In addition, the different versions of the upgrade software may consume large amounts of memory space, and may be largely repetitive since each error present in from-versions must be corrected in more than one software upgrade version.

It would be advantageous to have a system and method that overcomes the disadvantages of the existing methodology. The present invention provides such a system and method.

### SUMMARY OF THE INVENTION

The present invention looks at conversion software as a series of individual conversion steps that, taken together, convert a node's software from a from-version to a to-version. The present invention is directed to a method and system for selecting from a plurality of available conversion steps, a set of conversion steps that provides the shortest path between the from-version of the software system and the to-version of the software system.

Thus, in one aspect, the present invention is directed to a method of converting a software system from a first version to a second version. The method comprises the steps of storing in a conversion database, a list of software conversion steps and associated capabilities, wherein each conversion step performs a partial conversion of the software system, and different combinations of the conversion steps may be utilized to convert the software system from the first version to the second version, with each combination requiring a different number of conversion steps. The method then creates a software program for converting the software system from the first version to the second version by selecting the combination of conversion steps from the database that results in the fewest number of conversion steps being required. The software program may be created by building a conversion graph from the list of available conversion steps and capabilities, and searching the conversion graph to determine the shortest path from the first version to the second version.

In another aspect, the present invention is directed to a system for converting a software system from a first version to a second version. The system comprises a conversion database that stores a list of available software conversion steps, wherein each conversion step performs a partial conversion of the software system, and different combinations of the conversion steps may be utilized to convert the software system from the first version to the second version, with each combination requiring a different number of conversion steps. The system also includes means for selecting the combination of conversion steps from the database that results in the fewest number of conversion steps being required to convert the software system from the first version to the second version; and means for performing the selected combination of conversion steps on the software system. The selecting means may include means for building a conversion graph from the list of available conversion steps and capabilities, and a searching function that searches the conversion graph to determine the shortest path from the first version to the second version. The searching function may search the conversion graph utilizing a breadth-first searching technique.

### BRIEF DESCRIPTION OF THE DRAWINGS

Further objects and advantages of the present invention will become apparent from the following description of the preferred embodiments that are given by way of example with reference to the accompanying drawings wherein:

FIG. 1 is a simple conversion graph illustrating a series of conversion steps involved in converting a software system from version R1A to version R3B;

FIG. 2 is a more complex conversion graph illustrating a series of conversion steps involved in converting a software system from version 4.3TC4 to several other possible versions;

FIG. 3 is a flow chart illustrating the steps of an embodiment of the method of the present invention when converting a software system from a from-version to a to-version; and

FIG. 4 is a simplified block diagram of an embodiment of the system of the present invention.

### DETAILED DESCRIPTION OF EMBODIMENTS

The present invention, referred to herein as a Generic Upgrade Engine (GUE) looks at conversion software as a series of individual conversion steps that, taken together, convert a node's software from a from-version to a to-version. Each conversion step takes a particular input version and performs the conversion step to produce a particular output version. Each conversion step is implemented separately from the other conversion steps, and does not have any knowledge of the other steps. The GUE includes, or has access to, a database of available conversion steps and their capabilities. Given the available conversion steps and their capabilities, the GUE builds a conversion graph.

As the GUE is initialized, it is given a list of all the available conversion steps. Each conversion step “knows” which versions it connects. This information is accessed with two instructions: getFromRevision( ) and getToRevision( ). The GUE loops through the list and maps each conversion step into the graph. The graph is represented internally by a hash table that maps revision strings to linked lists containing conversion steps.

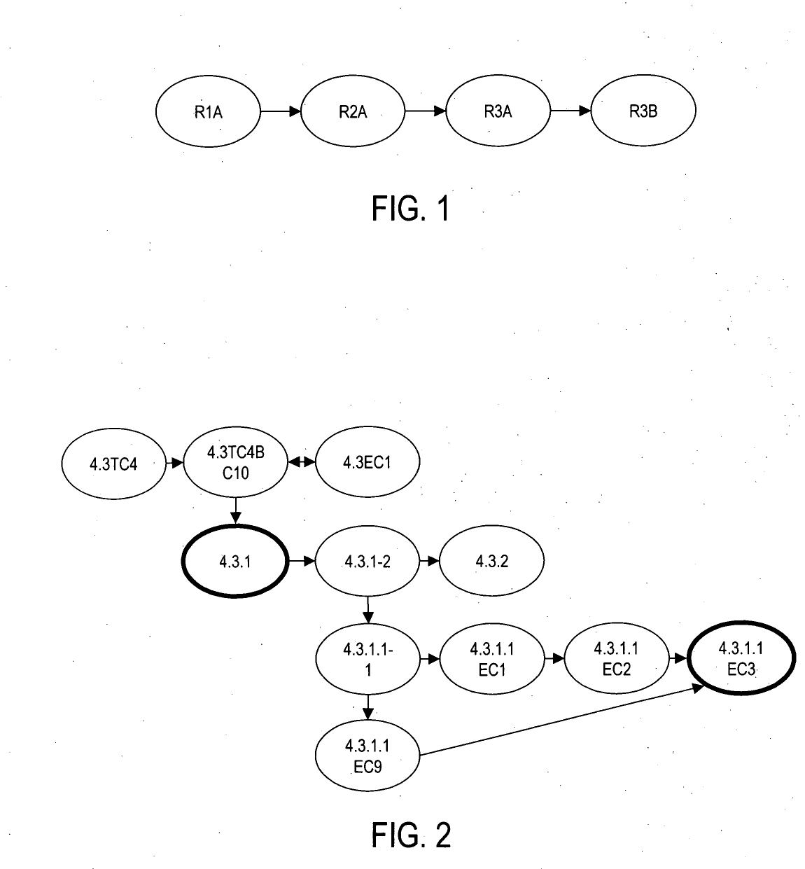

FIG. 1 is a simple conversion graph illustrating a series of conversion steps involved in converting a software system from version R1A to version R3B. This simple conversion graph includes steps that convert R1A to R2A, R2A to R3A, and R3A to R3B. If the software is being converted to one of the intermediate versions, only the necessary steps leading to that version are performed. For example, if the software is being converted from version R1A to version R3A, only the first two steps are performed. In the real world, of course, conversions are usually far more complex because different tracks must be maintained, and tracks often merge into each other or form loops.

FIG. 2 is a more complex conversion graph illustrating a series of conversion steps involved in converting a software system from version 4.3TC4 to several other possible versions. Different customers require different functionality and, in order to decrease the amount of time required to verify their software, customers generally do not want more functionality in their software than necessary. Therefore numerous upgrade steps, leading to numerous to-versions, must be supported. Note that the GUE can also handle downgrading steps (e.g., between version 4.3TC4BC10 and 4.3EC1), so that conversions can be done from higher revisions to lower.

After building the conversion graph, the GUE searches through the graph to find the shortest path between the from-version and the to-version. The GUE preferably uses a searching technique referred to as breadth-first searching. In breadth-first searching, the GUE starts at the from-version and first explores all of the versions to which the from-version connects directly (i.e., first-level versions) to determine whether any of the first-level versions are the to-version. If not, the GUE explores all of the versions to which the first-level versions connect (i.e., second-level versions) to determine whether any of the second-level versions are the to-version. This process continues until the to-version is found, and ensures that the to-version will be found in as few steps (levels) as possible. When the to-version is found, a track can be traced back to the from-version, thereby identifying each step in the conversion process.

For an example, the GUE may be instructed to convert from version 4.3.1 to version 4.3.1.1EC3. In this example, the GUE searches the conversion graph and finds two possible paths. The first path follows the path:
4.3.1→4.3.1-2→4.3.1.1-1→4.3.2.2EC1→4.3.1.1EC2→4.3.1.1EC3.
   The second path follows the path:
4.3.1→4.3.1-2→4.3.1.1-1→4.3.1.1EC9→4.3.1.1EC3.
   The GUE then selects the second path because it is the shortest path.

An additional problem arises when new versions of a system are released more frequently than the persistent data structure is changed. In other words, a new upgrade program is not delivered for every release. In this case, the GUE “guesses” which revisions the user is trying to upgrade between. When the GUE is given an “unknown” revision number for either the from-version or the to-version (i.e., one that is not mapped in the graph), it approximates the revision(s) by finding the closest predecessor(s) in the graph. For example, the conversion graph may support the revisions R1A, R2A, and R3A. The user may want to upgrade from R1A to R2B, which is a newly delivered correction of R2A. However, R2B is not directly supported by the conversion graph (as it is not in the list), so the GUE approximates R2B to R2A, which is the closest predecessor to R2B in the list. In this case, the upgrade path for this upgrade will be R1A→R2A.

Assuming that not all releases of the system affect the data that needs to be upgraded, the above example is a good guess. If a system version that actually requires additional upgrade functionality is inadvertently released without updating the upgrade program, the problem should be identified and corrected in the system verification phase. If a suitable approximation cannot be found by the “guessing” function, the GUE may abort the conversion and return to the original state.

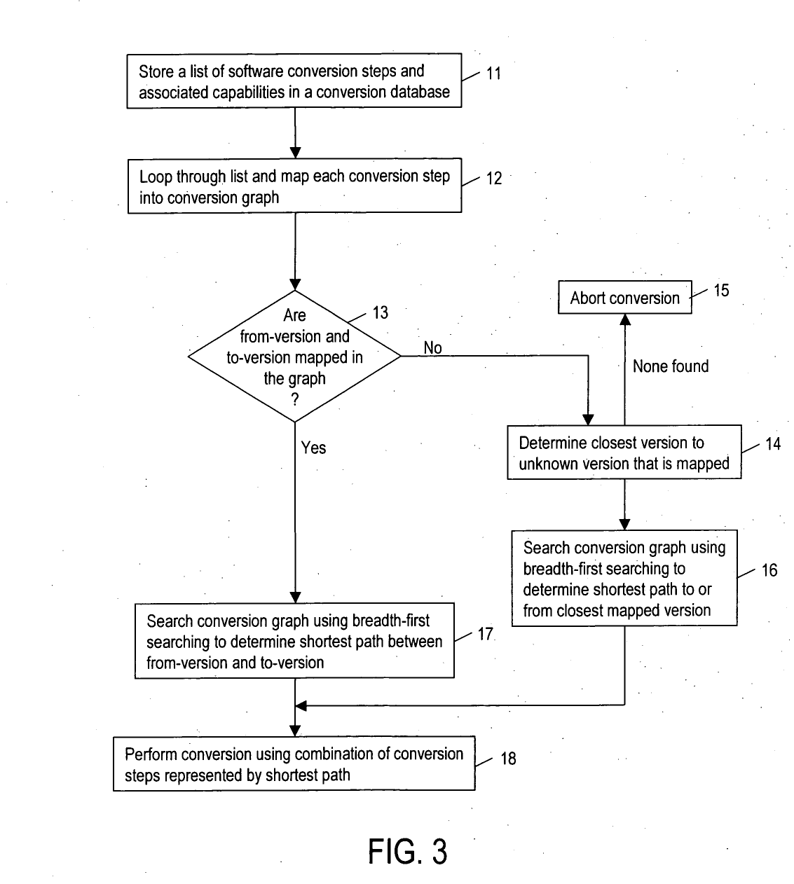

FIG. 3 is a flow chart illustrating the steps of an embodiment of the method of the present invention when converting a software system from a from-version to a to-version. At step 11, a list of software conversion steps and their associated capabilities are stored in a conversion database. At step 12, the GUE loops through the list and maps each conversion step into a conversion graph. At step 13, it is determined whether or not the from-version and the to-version of the software system being converted are mapped in the graph and are, therefore, known versions. If either the from-version or the to-version is not mapped, the method moves to step 14 where the GUE determines the closest version to the unknown version that is mapped. If a suitable approximation cannot be found, the GUE may abort the conversion at step 15 and return to the original state. If a suitable approximation is found, the GUE searches the conversion graph at step 16 using the breadth-first searching technique to determine the shortest path to or from the closest mapped version. The method then moves to step 18.

However, if it is determined at step 13 that the from-version and the to-version of the software system are both mapped in the conversion graph, the method moves instead to step 17 where the GUE searches the conversion graph using the breadth-first searching technique to determine the shortest path between the from-version and the to-version. Thereafter, at step 18, the software system is converted using the combination of conversion steps represented by the shortest path in the conversion graph.

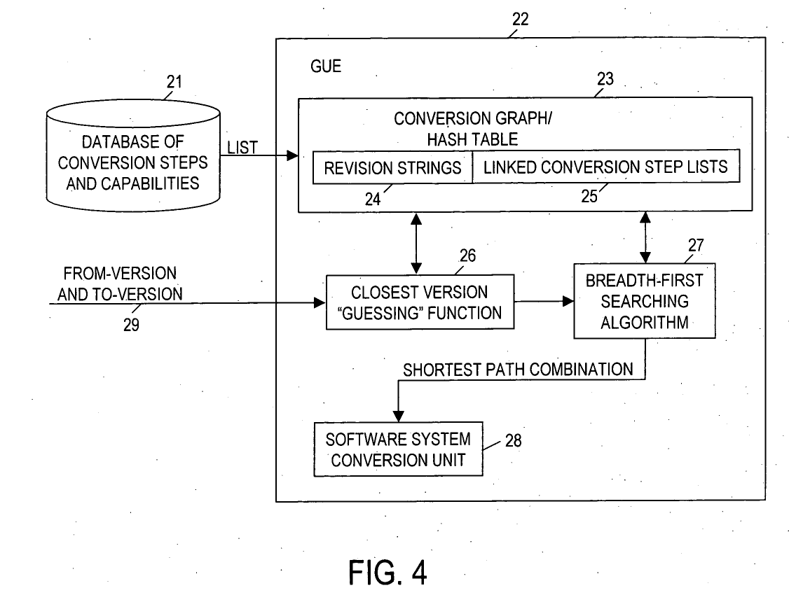

FIG. 4 is a simplified block diagram of an embodiment of the system of the present invention. A conversion database 21 stores a list of software conversion steps and their associated capabilities. The conversion database may be internal or external to a Generic Upgrade Engine (GUE) 22. The GUE includes a conversion graph/hash table 23, which maps software revision strings 24 to linked lists of conversion steps 25. The GUE also includes a closest version “guessing” function 26, a breadth-first searching algorithm 27, and a software system conversion unit 28. The GUE obtains the list of software conversion steps and associated capabilities from the conversion database and loops through the list, mapping each conversion step into the conversion graph. The conversion graph is represented internally as the hash table 23 that maps the software revision strings to the linked lists of conversion steps.

When the from-version and to-version of the software system 29 are input, the closest version “guessing” function 26 determines whether or not the from- and to-versions of the software system being converted are mapped in the conversion graph. If not, the closest version “guessing” function determines the closest version to the unknown version(s) that is mapped. The from- and to-versions (or alternatively, the closest version(s)) are then provided to the breadth-first searching algorithm 27, which searches the conversion graph using the breadth-first searching technique to determine the shortest path between the from- and to-versions or closest mapped versions. The shortest path combination of conversion steps is provided to the software system conversion unit 28, which converts the software system using the combination of conversion steps represented by the shortest path in the conversion graph.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of converting a software system from a first version to a second version, comprising:
storing in a conversion database, a list of software conversion steps, wherein each conversion step performs a partial conversion of the software system, and different combinations of the conversion steps may be utilized to convert the software system from the first version to the second version, with each combination requiring a different number of conversion steps; and
creating a software program for converting the software system from the first version to the second version by selecting the combination of conversion steps from the database that results in the fewest number of conversion steps being required.

2. The method of claim 1, wherein the step of storing the list of software conversion steps in a conversion database includes storing a list of available conversion steps and each conversion step's capabilities.

3. The method of claim 2, wherein the step of creating a software program for converting the software system includes:
building a conversion graph from the list of available conversion steps and capabilities; and
searching the conversion graph to determine the shortest path from the first version to the second version.

4. The method of claim 3, wherein the step of building the conversion graph includes:
accessing the list of available conversion steps and capabilities utilizing a getFromRevision( ) instruction and a getToRevision( ) instruction; and
looping through the list and mapping each conversion step into the conversion graph.

5. The method of claim 4, wherein the step of building the conversion graph also includes representing the conversion graph by a hash table that maps revision strings to linked lists containing conversion steps.

6. The method of claim 3, wherein the step of searching the conversion graph includes searching the conversion graph utilizing a breadth-first searching technique.

7. The method of claim 1, further comprising, before the step of creating a software program for converting the software system, the steps of:
determining whether any conversion step in the list supports converting to the second version of the software system;
if there is not a conversion step in the list that supports converting to the second version, determining the closest version to the second version that is supported by a step in the list; and
substituting the closest version for the second version when performing the step of creating the software program for converting the software system from the first version to the second version.

8. The method of claim 1, wherein the step of storing the list of software conversion steps in a conversion database includes storing conversion steps that upgrade the software system and conversion steps that downgrade the software system.

9. A system for converting a software system from a first version to a second version, comprising:
a conversion database that stores a list of available software conversion steps, wherein each conversion step performs a partial conversion of the software system, and different combinations of the conversion steps may be utilized to convert the software system from the first version to the second version, with each combination requiring a different number of conversion steps;
means for selecting the combination of conversion steps from the database that results in the fewest number of conversion steps being required to convert the software system from the first version to the second version; and
means for performing the selected combination of conversion steps on the software system.

10. The system of claim 9, wherein the conversion database also stores each conversion step's associated capabilities.

11. The system of claim 10, wherein the selecting means includes:
means for building a conversion graph from the list of available conversion steps and capabilities; and
a searching function that searches the conversion graph to determine the shortest path from the first version to the second version.

12. The system of claim 11, wherein the means for building the conversion graph includes a generic upgrade engine that loops through the list of available conversion steps and capabilities, and maps each conversion step into the conversion graph.

13. The system of claim 12, wherein the generic upgrade engine includes a hash table that maps revision strings to linked lists containing conversion steps.

14. The system of claim 11, wherein the searching function searches the conversion graph utilizing a breadth-first searching technique.

15. The system of claim 9, further comprising:
means for determining whether the second version of the software system is supported by a conversion step in the list of available conversion steps; and
means, responsive to a determination that there is not a conversion step in the list that supports converting to the second version, for determining the closest version to the second version that is supported by a step in the list,
wherein the means for selecting the combination of conversion steps selects a combination from the database that converts the software system from the first version to the closest supported version.

16. The system of claim 9, wherein the database stores conversion steps that upgrade the software system and conversion steps that downgrade the software system.
